(19) United States
(12) Patent Application Publication
(10) Pub. No.: US 2026/0260612 A1
(43) Pub. Date: Sep. 3, 2026

(54) DISPLAY PANEL AND DISPLAY APPARATUS

(71) Applicant: Wuhan Tianma Microelectronics Co., Ltd., Wuhan (CN)

(72) Inventor: Fen LIU, Wuhan (CN)

(73) Assignee: Wuhan Tianma Microelectronics Co., Ltd., Wuhan (CN)

(21) Appl. No.: 19/262,081

(22) Filed: Jul. 7, 2025

(30) Foreign Application Priority Data
Feb. 28, 2025 (CN) 202510237914.8

(51) Int. Cl. G09G 3/3233; G09G 3/20; G09G 3/3266

(52) U.S. Cl. CPC G09G 3/3233; G09G 3/2074; G09G 3/3266; G09G 2300/0426; G09G 2300/0804; G09G 2300/0852; G09G 2300/0861; G09G 2310/0286; G09G 2310/062; G09G 2320/0233; G09G 2320/0257

(57) ABSTRACT

The present application discloses a display panel and a display apparatus. In the display panel, a gate of the first transistor in the first sub-pixel is connected to a first scanning line, a gate of the first transistor in the second sub-pixel is connected to a second scanning line, and gates of the second transistors in the first sub-pixel and the second sub-pixel are connected to a third scanning line. In one screen refresh cycle, a first scan signal on the first scanning line comprises a first active level, a second scan signal on the second scanning line comprises a second active level, a third scan signal on the third scanning line comprises a third active level, and a period of the third active level covers a period of the first active level and a period of the second active level.

### CROSS-REFERENCE TO RELATED APPLICATION

This application claims priority to Chinese Patent Application No. 202510237914.8, filed on Feb. 28, 2025, which is hereby incorporated by reference in its entirety.

### TECHNICAL FIELD

The present application relates to the field of display technology, and particularly, to a display panel and a display apparatus.

### BACKGROUND

From the age of Cathode Ray Tube (CRT) to the age of Liquid Crystal Display (LCD), and now to the age of Organic Light-Emitting Diode (OLED) and light-Emitting Diode display (LED), the display industry has experienced decades of development and has been rapidly changing. The display industry has been closely related to our lives: from traditional mobile phones, tablets, televisions, and PCs to current smart wearable devices, VR, and vehicle displays, none of which are inseparable from the display technology.

With the continuous development of display technologies, users have more and more requirements for display effects. Therefore, how to optimize the display effect of the display panel is a technical problem that those skilled in the art are committed to solving.

### SUMMARY

Embodiments of the present application provide a display panel and a display apparatus, which can improve display effective.

In one aspect, an embodiment of the present application provides a display panel including: a sub-pixel comprising a driving transistor, a first transistor, and a second transistor, the first transistor being connected between a data line and a first electrode of the driving transistor, and the second transistor being connected between a second electrode of the driving transistor and a gate of the driving transistor. A plurality of the sub-pixels comprise a first sub-pixel and a second sub-pixel, a gate of the first transistor in the first sub-pixel is connected to a first scanning line, a gate of the first transistor in the second sub-pixel is connected to a second scanning line, and gates of the second transistors in the first sub-pixel and the second sub-pixel are connected to a third scanning line.

In one screen refresh cycle, a first scan signal on the first scanning line comprises a first active level, a second scan signal on the second scanning line comprises a second active level, a third scan signal on the third scanning line comprises a third active level, a period of the third active level covers a period of the first active level and a period of the second active level, and a start time of the second active level is no earlier than an end time of the first active level. A difference between a first cut-off level and the first active level of the first scanning signal is ΔV1, a difference between a second cut-off level and the second active level of the second scanning signal is ΔV2, a duration of the first active level is t1, and a duration of the second active level is t2, where |ΔV1|*t1<|ΔV2|*t2.

In another aspect, the embodiments of the present application provide a display apparatus including the display panel according to the above embodiments. The display panel comprises: a sub-pixel comprising a driving transistor, a first transistor, and a second transistor, the first transistor being connected between a data line and a first electrode of the driving transistor, and the second transistor being connected between a second electrode of the driving transistor and a gate of the driving transistor. A plurality of the sub-pixels comprise a first sub-pixel and a second sub-pixel, a gate of the first transistor in the first sub-pixel is connected to a first scanning line, a gate of the first transistor in the second sub-pixel is connected to a second scanning line, and gates of the second transistors in the first sub-pixel and the second sub-pixel are connected to a third scanning line. In one screen refresh cycle, a first scan signal on the first scanning line comprises a first active level, a second scan signal on the second scanning line comprises a second active level, a third scan signal on the third scanning line comprises a third active level, a period of the third active level covers a period of the first active level and a period of the second active level, and a start time of the second active level is no earlier than an end time of the first active level. A difference between a first cut-off level and the first active level of the first scanning signal is ΔV1, a difference between a second cut-off level and the second active level of the second scanning signal is ΔV2, a duration of the first active level is t1, and a duration of the second active level is t2, where |ΔV1|*t1<|ΔV2|*t2.

### BRIEF DESCRIPTION OF THE DRAWINGS

Other features, objects, and advantages of the present application will become more apparent from the following detailed description of non-limiting embodiments with reference to the accompanying drawings, in which same or similar reference numerals indicate same or similar features. The drawings are not drawn according to actual scale.

FIG. 1 shows a structural schematic diagram of a circuit of a sub-pixel in the related art;

FIG. 2 shows a timing schematic diagram corresponding to FIG. 1;

FIG. 3 shows a structural schematic diagram of a display panel according to an embodiment of the present application;

FIG. 4 shows a structural schematic diagram of a circuit of a sub-pixel according to an embodiment of the present application;

FIG. 5 shows a timing schematic diagram of a display panel according to an embodiment of the present application;

FIG. 6 shows a structural schematic diagram of a display panel according to another embodiment of the present application;

FIG. 7 shows a structural schematic diagram of a circuit of a shift register in a display panel according to an embodiment of the present application;

FIG. 8 shows a timing schematic diagram of a display panel according to another embodiment of the present application;

FIG. 9 shows a timing schematic diagram of a display panel according to yet another embodiment of the present application;

FIG. 10 shows a structural schematic diagram of a display panel according to yet another embodiment of the present application;

FIG. 11 shows a structural schematic diagram of a display panel according to yet another embodiment of the present application;

FIG. 12 shows a structural schematic diagram of a display panel according to yet another embodiment of the present application;

FIG. 13 shows a structural schematic diagram of a circuit of a sub-pixel according to another embodiment of the present application;

FIG. 14 shows a structural schematic diagram of a layout of a partial area of a display panel according to an embodiment of the present application;

FIG. 15 shows a structural schematic diagram of a layout of a partial area of a display panel according to another embodiment of the present application;

FIG. 16 shows a structural schematic diagram of a layout of a partial area of a display panel according to still yet another embodiment of the present application;

FIG. 17 shows a structural schematic diagram of a display panel according to yet another embodiment of the present application;

FIG. 18 shows a schematic structural diagram of a display apparatus according to an embodiment of the present application.

### DETAILED DESCRIPTION

Features of various aspects and exemplary embodiments of the present application will be described in detail below. In order to make objects, technical solutions and advantages of the present application clearer, the present application is further described in detail below with reference to the drawings and specific embodiments. It should be understood that the specific embodiments described herein are only used to explain the present application, but not to limit the present application. For those skilled in the art, the present application can be implemented without some of these specific details. The following description of the embodiments is only to provide a better understanding of the present application by illustrating examples of the present application.

It should be noted that, in the present application, the relational terms, such as first and second, are used merely to distinguish one entity or operation from another entity or operation, without necessarily requiring or implying any actual such relationships or orders for these entities or operations. Moreover, the terms “comprise”, “include”, or any other variants thereof, are intended to represent a non-exclusive inclusion, such that a process, method, article or device including a series of elements includes not only those elements, but also other elements that are not explicitly listed or elements inherent to such a process, method, article or device. Without more constraints, the elements following an expression “comprise/include . . . ” do not exclude the existence of additional identical elements in the process, method, article or device that includes the elements.

It should be understood that when the structure of a component is described, if a layer/area is referred to as being “on” or “above” another layer/region, it may mean that the layer/area is directly on the other layer/region or that other layers/regions may be included between the layer/area and the other layer/area. Moreover, if the component is turned over, the layer/area will be “below” or “under” the other layer/area.

It should be understood the term “and/or” used herein refers to only an association relationship for describing associated objects, and means that there may be three kinds of relationships. For example, “A and/or B” may represent three cases including: “A exists alone”, “A and B exist simultaneously”, and “B exists alone”. In addition, the character “/” herein generally indicates that the associated objects have an “or” relationship.

In the description of the embodiments of the present application, the technical terms “mounted”, “connected”, “connection”, “fixed”, and the like should be interpreted in a broad sense, for example, they may refer to a fixed connection, a detachable connection or integration; a mechanical connection, or an electrical connection; a direct connection, an indirect connection through an intermediate medium, or an internal connection or an interaction relationship between two elements. For those of ordinary skill in the art, the specific meanings of the above terms in the embodiments of the present application may be understood in accordance with specific conditions.

It will be apparent to those skilled in the art that various modifications and variations can be made in the present application without departing from the gist or scope of the present application. Therefore, the present application is intended to cover modifications and variations of the present application that fall within the scope of the corresponding claims (claimed technical solutions) and their equivalents. It should be noted that, the embodiments according to the present application may be combined with each other as long as there is no contradiction.

Before describing the technical solutions according to the embodiments of the present application, the present application first specifically describes the problems existing in the related art to facilitate understanding of the embodiments of the present application.

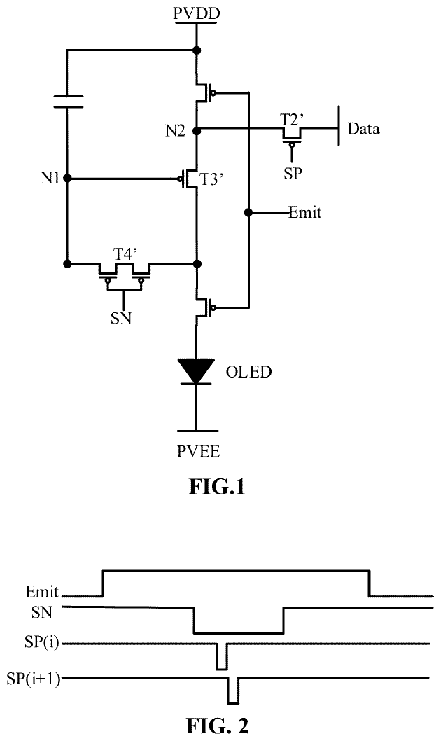

As shown in FIG. 1, a sub-pixel generally includes a driving transistor T3′, a data writing transistor T2′, and a threshold compensation transistor T4′, a first pole of the data writing transistor T2′ being connected to a data line data, a second pole of data writing transistor T2′ and a first pole of the driving transistor T3′ being connected to a node N2, a first pole of the threshold compensation transistor T4′ and a gate of the driving transistor T3′ being connected to a node N1, and a first pole of the threshold compensation transistor T4′ is connected to a second pole of the driving transistor T3′. The data writing transistor is configured to write a data voltage to the gate of the driving transistor, and the threshold compensation transistor is configured to compensate the threshold voltage of the driving transistor. For example, a scan signal to which the gate of the data writing transistor T2′ is accessed is referred to as an SP signal, and a signal to which the gate of the threshold compensation transistor is accessed is referred to as an SN signal.

In the related art, in order to improve the image sticking issue of an OLED display panel under low-frequency driving, a same SP signal is configured to drive one row of sub-pixels, and a same SN signal is configured to drive two rows of sub-pixels. For example, as shown in FIG. 2, the i^{th} row of sub-pixels is connected to the SP (i) signal, the i+1^{th} row of sub-pixels is connected to the SP (i+1) signal, and the i^{th} and the i+1^{th} rows of sub-pixel are connected to the SN signal. Taking for example, in FIG. 1, that the low level of the SP signal is an active level and the low level of the SN signal is an active level, the active level refer to a level by which the transistor can be controlled to turn on. The SP (i) signal becomes a low level first, and the SP (i+1) signal becomes a low level later; when the SP (i+1) signal is a low level, since the SN signal is still active level, the voltage of node N2 in the i^{th} sub-pixel will still be written to node N1, resulting in a difference in writing duration of data voltages of the two rows of sub-pixels, different writing capabilities of data voltages of the two rows of sub-pixels, different driving currents of the two rows of sub-pixels, and thus a luminance difference between the two rows of sub-pixels (for example, one row is bright and another is dark), thereby easily causing a problem of fine and dense horizontal stripes.

In order to solve the problems described above, the embodiments of the present application provide a display panel and a display apparatus, which will be described below with reference to the accompanying drawings.

The embodiments of the present application provide a display panel, and the display panel may be an organic light emitting diode (OLED) display panel.

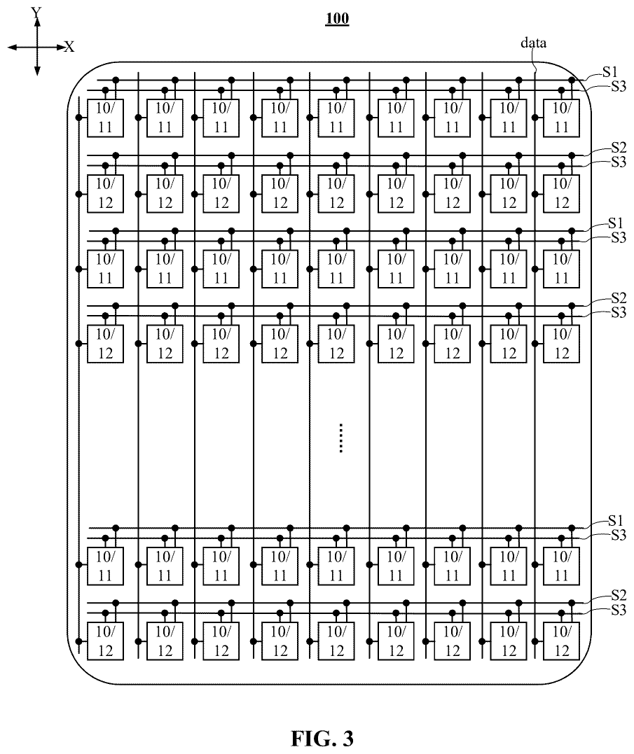

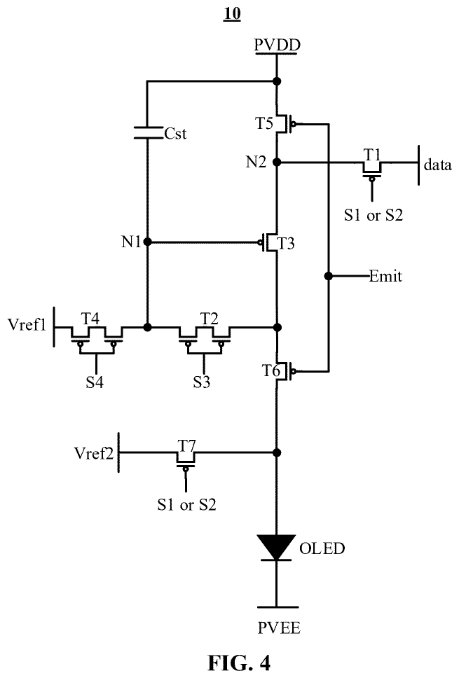

Referring to FIGS. 3 and 4, the display panel 100 includes a sub-pixel 10 which includes a driving transistor T3, a first transistor T1, and a second transistor T2. A first transistor T1 is connected between the data line data and the first pole of the driving transistor T3, and the second transistor T2 is connected between the second pole of the driving transistor T3 and the gate of the driving transistor T3.

Specifically, the first pole of the first transistor T1 is connected to the data line data, and the first pole of the first transistor T1 and the first pole of the driving transistor T3 are connected to the node N2. The first electrode of the second transistor T2 and the gate of the driving transistor T3 are connected to the node N1, and the second electrode of the second transistor T2 and the second electrode of the driving transistor T3 are connected to the node N1. The first transistor T1 is configured to write a data voltage to the driving transistor T3, and the second transistor T2 is configured to compensate the threshold voltage of the driving transistor T3. The first transistor T1 may be referred to as a data writing transistor, and the second transistor T2 may be referred to as a threshold compensation transistor.

The plurality of sub-pixels 10 are arranged in an array in the first direction X and the second direction Y. The first direction X and the second direction Y intersect. For example, the first direction X is a row direction, and the second direction Y is a column direction. Of course, the row direction and the column direction are interchangeable.

The sub-pixel 10 includes a first sub-pixel 11 and a second sub-pixel 12, the gate of the first transistor T1 in the first sub-pixel 11 is connected to the first scanning line S1, the gate of the first transistor T1 in the second sub-pixel 12 is connected to the second scanning line S2, and the gates of the second transistors T2 in both the first sub-pixel 11 and the second sub-pixel 12 are connected to the third scanning line S3.

As an example, the first scanning line S1, the second scanning line S2, and the third scanning line S3 all extend in the first direction X, and the first sub-pixel 11 and the second sub-pixel 12 connecting the same third scanning line S3 are adjacent to each other in the second direction Y. Taking for example that the first direction X is the row direction, the first scanning line S1 is configured to drive a pixel row in which the first sub-pixel 11 is located, the second scanning line S2 is configured to drive a pixel row in which the second sub-pixel 12 is located, and the third scanning line S3 is configured to drive a pixel row in which the first sub-pixel 11 and the second sub-pixel 12 are located. In other words, the first scanning line S1 is configured to drive one row of sub-pixels, the second scanning line S2 is configured to drive one row of sub-pixels, and the third scanning line S3 is configured to drive at least two rows of sub-pixels.

Exemplarily, the pixel row in which the first sub-pixel 11 is located is an odd-numbered row, and the pixel row in which the second sub-pixel 12 is located is an even-numbered row.

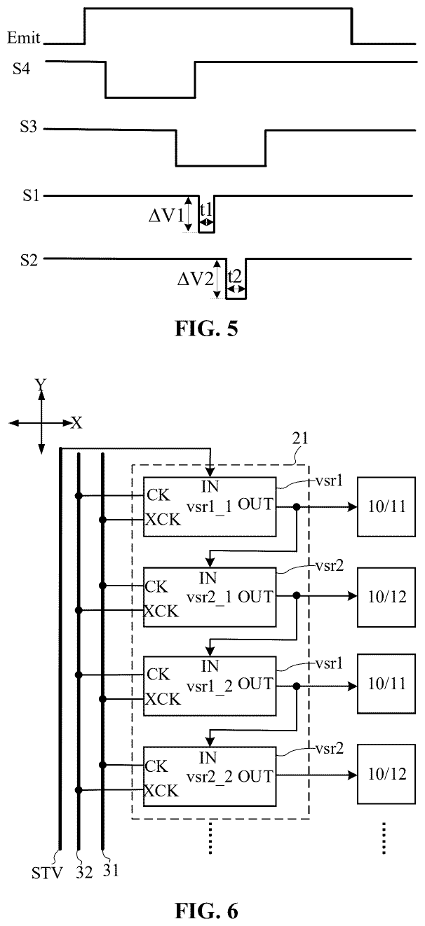

As shown in FIG. 5, in one screen refresh cycle, the first scan signal on the first scanning line S1 includes a first active level, the second scan signal on the second scanning line S2 includes a second active level, and the third scan signal on the third scanning line S3 includes a third active level. The period of the third active level covers the period of the first active level and the period of the second active level, and the start time of the second active level is no earlier than the end time of the first active level. The difference between the first cut-off level and the first active level of the first scanning signal is ΔV1, the difference between the second cut-off level and the second active level of the second scanning signal is ΔV2, the duration of the first active level is t1, and the duration of the second active level is t2, where |ΔV1|*t1<|ΔV2|*t2.

As one example, |ΔV1|<|ΔV2|, and t1=t2.

As another example, |ΔV1|=|ΔV2|, and t1<t2.

As yet another example, |ΔV1|<|ΔV2|, and t1<t2.

It can be understood that the start time of the second active level on the second scanning line S2 is not earlier than the end time of the first active level on the first scanning line S1, and the first sub-pixel writes the data voltage first, and then the second sub-pixel writes the data voltage. As an example, the end time of the first active level on the first scanning line S1 and the start time of the second active level on the second scanning line S2 differ by a duration of 1H, where H=1/(F*n), F refers to the refresh frequency of the display panel, and n refers to the total number of rows of sub-pixels.

After the first scanning signal on the first scanning line S1 is switched from the first active level to the first cut-off level, since the signal on the third scanning line is still at an active level, the level of the node N2 in the first sub-pixel 11 is still written to the node N1. That is, the data voltage is still written to the gate of the driving transistor in the first sub-pixel 11, and the writing of the data voltage is stopped until the driving transistor in the first sub-pixel 11 is turned off.

When |ΔV1|<|ΔV2|, the difference between the second cut-off level and the second active level on the second scanning line S2 is greater, so that the first transistor T1 in the second sub-pixel 12 is turned on more sufficiently, and the sufficiency of the data voltage writing of the second sub-pixel 12 is increased to compensate for the luminance difference caused by the data voltage writing duration of the first sub-pixel 11 being longer than the data voltage writing duration of the second sub-pixel 12.

When t1<t2, the data voltage writing duration of the second sub-pixel 12 is directly increased, and the luminance difference caused by the data voltage writing duration of the first sub-pixel 11 being longer than that of the second sub-pixel 12 is directly compensated.

FIG. 5 schematically illustrates that the active levels on the first scanning line S1, the second scanning line S2, and the third scanning line S3 are low levels and the cut-off levels on the first scanning line S1, the second scanning line S2, and the third scanning line S3 are high levels, and in this case, the first transistor and the second transistor are P-type transistors. However, this is not intended to limit the present application. The transistor in the embodiment of the present application may be an N-type transistor or a P-type transistor. For N-type transistors, the active level is high and the cut-off level is low. That is, when the gate potential of the N-type transistor is a high level, the first pole and second pole thereof are turned on, and when the gate potential of the N-type transistor is a low level, the first and second poles thereof are turned off. For a P-type transistor, the active level is low and the cut-off level is high. That is, when the gate potential of the P-type transistor is at a low level, the first pole and the second pole thereof are turned on, and when the gate potential of the P-type transistor is at a high level, the first pole and the second pole thereof are turned off.

It will be understood that both t1 and t2 are positive numbers. When the first transistor and the second transistor are P-type transistors, the first cut-off level and the second cut-off level are positive voltages, the first active level and the second active level are negative voltages, and ΔV1 and ΔV2 are positive numbers. When the first transistor and the second transistor are N-type transistors, the first cut-off level and the second cut-off level are negative voltages, the first active level and the second active level are positive voltages, and ΔV1 and ΔV2 are negative numbers.

In this embodiment, the first scanning line is connected to the gate electrode of the first transistor in the first sub-pixel, the second scanning line is connected to the gate electrode of the first transistor in the second sub-pixel, and the third sub-pixel is connected to the gate electrode of the first sub-pixel and the gate electrode of the second transistor in the second sub-pixel. The signal on the first scanning line is an active level first, the signal on the second scanning line is an active level later, and the signals on the first scanning line and the second scanning line conform to the relationship of |ΔV1|*t1<|ΔV2|*t2, which can increase the sufficiency of the data voltage writing of the second sub-pixel, and/or directly increase the data voltage writing duration of the second sub-pixel, thereby compensating for the luminance difference caused by the data voltage writing duration of the first sub-pixel being greater than that of the second sub-pixel.

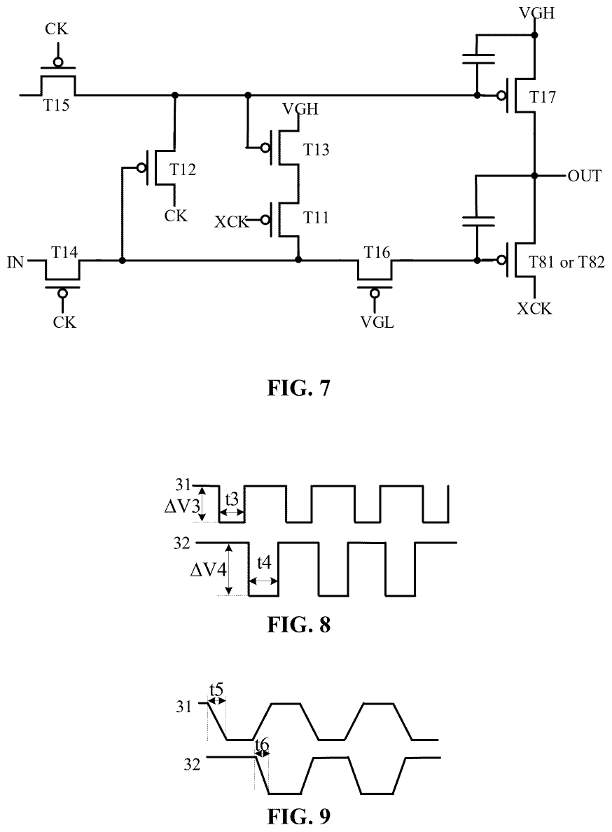

In some embodiments, the display panel includes a scanning circuit, referring to FIGS. 6 and 7, which includes a first scanning circuit 21, and the first scanning circuit 21 includes a shift register. The shift registers include a first shift register vsr1 and a second shift register vsr2.

The circuit configurations of the first shift register vsr1 and the second shift register vsr2 may be the same. As an example, the circuit configuration of both the first shift register vsr1 and the second shift register vsr2 may be as shown in FIG. 7.

An output terminal OUT of the first shift register vsr1 is connected to the first scanning line S1 and a first terminal of the first output transistor T81, and a second terminal of the first output transistor T81 is connected to the first clock line 31.

The output terminal OUT of the second shift register vsr2 is connected to the second scanning line S2 and the first terminal of the second output transistor T82, and the second terminal of the second output transistor T82 is connected to the second clock line 32.

For example, in order to facilitate the description of the connection relationship between both of the first shift register vsr1 and the second shift register vsr2 and the clock line, taking the example where the first shift register vsr1 and the second shift register vsr2 each includes a first clock terminal CK and a second clock terminal XCK, the second terminal of the first output transistor T81 is connected to the second clock terminal XCK in the first shift register vsr1, and the second clock terminal XCK in the first shift register vsr1 is connected to the first clock line 31. The second terminal of the second output transistor T82 is connected to the second clock terminal XCK in the second shift register vsr2, and the second clock terminal XCK in the second shift register vsr2 is connected to the second clock line 32.

It is understood that the first shift register vsr1 is configured to provide a scan signal to the first transistor in the first sub-pixel, and the second shift register vsr2 is configured to provide a scan signal to the first transistor in the second sub-pixel. For example, if the first sub-pixel is an odd-numbered row sub-pixel, the second sub-pixel is an even-numbered row sub-pixel, the first shift register vsr1 is configured to drive the odd-numbered row sub-pixel, and the second shift register vsr2 is configured to drive the even-numbered row sub-pixel.

For example, as shown in FIG. 8, the difference between the third cut-off level and the third active level of the first clock signal on the first clock line 31 is ΔV3, and the difference between the fourth cut-off level and the fourth active level of the second clock signal on the second clock line 32 is ΔV4, where |ΔV3|<|ΔV4|.

The first clock signal on the first clock line 31 is configured to control the generation of the first scanning signal on the first scanning line S1. The difference between the cut-off level and the active level on the first scanning line S1 is equal to the difference between the cut-off level and the active level on the first clock line 31. In other words, |ΔV1|=|ΔV3|.

The second clock signal on the second clock line 32 is configured to control the generation of the second scan signal on the second scanning line S2. The difference between the cut-off level and the active level on the second scanning line S2 is equal to the difference between the cut-off level and the active level on the second clock line 32. In other words, |ΔV2|=|ΔV4|.

In this embodiment, the clock signal on the first clock line is configured to control the generation of the first scanning signal on the first scanning line, and the clock signal on the second clock line is configured to control the generation of the second scanning signal on the second scanning line. It can be achieved that the difference between the cut-off level and the active level on the first scanning line and the difference between the cut-off level and the active level on the second scanning line can be differentiated by differentiating the difference between the cut-off level and the active level on the first clock line and the difference between the cut-off level and the active level on the second clock line.

In some embodiments, the high level on the first clock line 31 is less than the high level on the second clock line 32, and/or the low level on the first clock line 31 is greater than the low level on the second clock line 32.

Taking for example that the cut-off level is a high level and the active level is a low level, the third cut-off level on the first clock line 31 is less than the fourth cut-off level on the second clock line 32, and/or the third active level on the first clock line 31 is greater than the fourth active level on the second clock line 32.

For example, in the initial case, there are the same high level and low level on the first clock line and the second clock line, respectively.

As one example, a high level on a first clock line is pulled low and a high level on a second clock line is pulled high; and/or the low level on the first clock line is pulled high and the low level on the second clock line is pulled low, such that a difference between the high level and the low level on the first clock line is greater than a difference between the high level and the low level on the second clock line.

As another example, the high level on the first clock line is pulled low, the high level on the second clock line is kept unchanged; and/or the low level on the first clock line is pulled high and the low level on the second clock line is kept unchanged, such that a difference between the high level and the low level on the first clock line is greater than a difference between the high level and the low level on the second clock line.

As yet another example, the high level on the first clock line is kept unchanged, the high level on the second clock line is pulled high; and/or the low level on the first clock line is kept unchanged, the low level on the second clock line is pulled low, such that a difference between the high level and the low level on the first clock line is greater than the difference between the high level and the low level on the second clock line.

In this embodiment, the high level voltage value transmitted by the first clock line is less than that transmitted by the second clock line, and/or the low level transmitted by the first clock line is greater than the low level transmitted by the second clock line, so that the difference between the high level and the low level on the first clock line is greater than the difference between the high level and the low level on the second clock line, and thus the difference between the cut-off level and the active level on the first scanning line and the cut-off level and the active level on the second scanning line are differentiated.

In some embodiments, referring to FIGS. 6 to 8, the display panel includes a scanning circuit, which includes a first scanning circuit 21 including a shift register. The shift registers include a first shift register vsr1 and a second shift register vsr2.

An output terminal OUT of the first shift register vsr1 is connected to the first scanning line S1 and a first terminal of the first output transistor T81, and a second terminal of the first output transistor T81 is connected to the first clock line 31. The output terminal OUT of the second shift register vsr2 is connected to the second scanning line S2 and the first terminal of the second output transistor T82, and the second terminal of the second output transistor T82 is connected to the second clock line 32.

The duration of the third active level on the first clock line 31 is t3, and the duration of the fourth active level on the second clock line 32 is t4, where t3<t4.

In the drawings of the present application, active levels on the first scanning line, the second scanning line, the first clock line, and the second clock line are schematically illustrated as low levels.

The first clock signal on the first clock line 31 is configured to control the generation of the first scanning signal on the first scanning line S1, and the third active level on the first clock line 31 is equal to the first active level on the first scanning line S1. In other words, t1=t3.

The second clock signal on the second clock line 32 is configured to control the generation of the second scan signal on the second scanning line S2. The fourth active level on the second clock line 32 is equal to the second active level on the second scanning line S2. In other words, t2=t4.

For example, in the initial case, the initial duration of the third active level on the first clock line is equal to the initial duration of the fourth active level on the second clock line.

As one example, the initial duration of the third active level on the first clock line may be shortened, and the initial duration of the fourth active level on the second clock line may be kept unchanged.

As another example, the initial duration of the third active level on the first clock line may be kept unchanged and the initial duration of the fourth active level on the second clock line may be shortened.

As yet another example, the initial duration of the third active level on the first clock line may be shortened, and the initial duration of the fourth active level on the second clock line may be shortened.

In this embodiment, the clock signal on the first clock line is configured to control the generation of the first scanning signal on the first scanning line, and the clock signal on the second clock line is configured to control the generation of the second scanning signal on the second scanning line. The differentiation between the duration of the active level on the first scanning line and the duration of the active level on the second scanning line can be realized by differentiating the duration of the active level on the first clock line and the duration of the active level on the second clock line.

Exemplarily, the delay corresponding to the first shift register may be increased, and/or the delay of the second shift register may be decreased, such that t3<t4.

In some embodiments, as shown in FIG. 9, the switching duration between the high level and the low level on the first clock line 31 is t5, and the switching duration between the high level and the low level on the second clock line 32 is t6, where t5>t6.

For example, an initial switching duration between a high and low level on a first clock line and an initial switching duration between a high and low level on a second clock line.

As one example, the initial switching duration between the high level and the low level on the first clock line may be increased, and the initial switching duration between the high level and the low level on the second clock line may be kept unchanged.

As another example, the initial switching duration between the high level and the low level on the first clock line may be kept unchanged and the initial switching duration between the high level and the low level on the second clock line may be reduced.

As yet another example, the initial switching duration between the high level and the low level on the first clock line may be increased and the initial switching duration between the high level and the low level on the second clock line may be decreased.

The longer the switching duration between the high level and the low level on the clock line is, the shorter the active level on the clock line is. In this embodiment, the switching duration between the high level and the low level on the first clock line is designed to be less than the switching duration between the high level and the low level on the second clock line, so that the duration of the active level on the first clock line can be less than the duration of the active level on the second clock line, and finally, the duration of the active level on the first scanning line can be less than the duration of the active level on the second scanning line.

In addition to adjusting the timing of the first clock line and the second clock line, the delay corresponding to the first shift register may be increased and/or the delay of the second shift register may be reduced by adjusting the physical structure so that t3<t4.

As one example, the line width of the first clock line 31 is smaller than the line width of the second clock line 32.

The smaller the line width of the clock line, the greater the load of the clock line, resulting in a greater signal delay on the clock line. In the present embodiment, the line width of the first clock line is smaller and the line width of the second clock line is larger, so that the load of the first clock line is greater than the load of the second clock line, and the duration of the third active level on the first clock line is less than the duration of the fourth active level on the second clock line.

For example, the line widths of the first clock line and the second clock line range from 2 to 20 μm, and the line width of the first clock line is smaller than that of the second clock line.

Through a large number of studies, the inventors have found that the ratio of the line width of the second clock line to the line width of the first clock line can be designed to be between 1.1 and 1.5, so as to better improve the problem that there is a luminance difference between the first sub-pixel and the second sub-pixel.

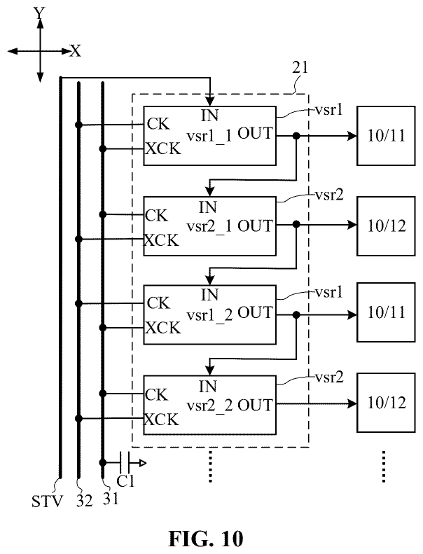

As another example, as shown in FIG. 10, the display panel further includes a compensation capacitor C1 connected to the first clock line 31.

The compensation capacitor C1, to which the first clock line 31 is connected, serves as the load of the first clock line 31, and the second clock line 32 is not provided with the compensation capacitor, so that the load of the first clock line is greater than the load of the second clock line, and thus the duration of the third active level on the first clock line is less than the duration of the fourth active level on the second clock line.

Through a large number of studies, the inventors have found that the capacitance value of the compensation capacitor C1 can be designed to be 10% to 50% of the total capacitance value on the first clock line, so as to better improve the problem of luminance difference between the first sub-pixel and the second sub-pixel. Exemplarily, the total capacitance on the first clock line includes a capacitance to which the first clock line is connected and a total capacitance value of the coupling capacitances between the first clock line and other signal lines.

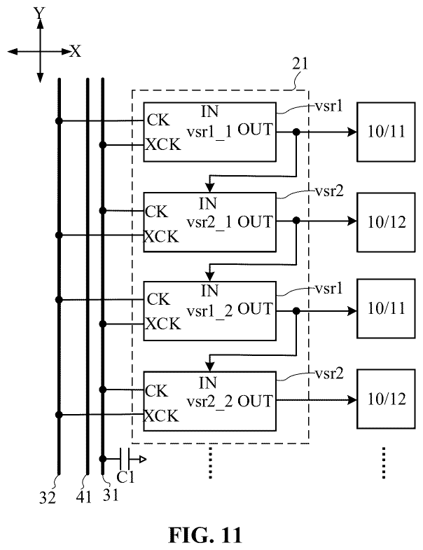

As another example, as illustrated in FIG. 11, the display panel includes a first signal line 41, and the spacing between the first clock line 31 and the first signal line 41 is smaller than the spacing between the second clock line 32 and the first signal line 41.

Exemplarily, the first signal line 41 includes, but is not limited to, a high-level signal line, a low-level signal line, a trigger signal line, and the like.

A coupling capacitance is formed between the first signal line 41 and the clock line, and the coupling capacitance between the first signal line 41 and the clock line is smaller as the spacing between them is larger. Conversely, the coupling capacitance between the first signal line 41 and the clock line is larger as the spacing between them is smaller.

In this embodiment, the spacing between the first clock line and the first signal line is smaller, and the spacing between the second clock line and the first signal line is larger; the coupling capacitance between the first clock line and the first signal line is greater, and the coupling capacitance between the second clock line and the first signal line is less, which is equivalent to the total capacitance value on the first clock line, and the total capacitance value on the first clock line is reduced, thereby increasing the load of the first clock line and reducing the load of the second clock line. Thus, the duration of the third active level on the first clock line is less than the duration of the fourth active level on the second clock line.

Through a large number of studies, the inventors have found that the total capacitance value on the first clock line can be increased by 10% to 50% of its initial value, and the total capacitance value on the second clock line can be decreased by 10% to 50% of its initial value, so as to better improve the problem of luminance difference between the first sub-pixel and the second sub-pixel.

The inventors have also found through research that the spacing between the first clock line 31 and the first signal line 41 can be reduced from 3.5 to 4.5 μm to 2 to 2.5 μm, and the spacing between the second clock line 32 and the first signal line 41 can be kept at 3.5 to 4.5 μm, so as to better improve the problem of luminance difference between the first sub-pixel and the second sub-pixel.

In some embodiments, as shown in FIG. 6, the first scanning circuit 21 includes a plurality of first shift registers vsr1 and a plurality of second shift registers vsr2 that are concatenated.

A second shift register is concatenated between every two adjacent first shift registers, and a first shift register is concatenated between every two adjacent second shift registers. The signal output from the output terminal of the first shift register serves as a trigger signal for the second shift register of the next stage thereof, and the signal output from the output of the second shift register serves as a trigger signal for the first shift register of the next stage thereof.

For example, the output terminal OUT of the first shift register vsr1_1 is connected to the input terminal IN of the second shift register vsr_1, the output terminal OUT of the second shift register vsr2_1 is connected to the input terminal IN of the first shift register vsr_2, the output terminal OUT of the first shift register vsr1_2 is connected to the input terminal IN of the second shift register vsr2_2, and so on. Further, the input terminal IN of the first shift register vsr1_1 is connected to the trigger signal line STV.

The clock terminal CK of the first shift register is also connected to the second clock line 32, and the clock terminal CK of the second shift register is also connected to the first clock line 31.

In this embodiment, two clock lines are configured to drive the first shift register and the second shift register, and the scanning signals on the first scanning line and the second scanning line can be differentiated only by differentiating the signal timing on the two clock lines.

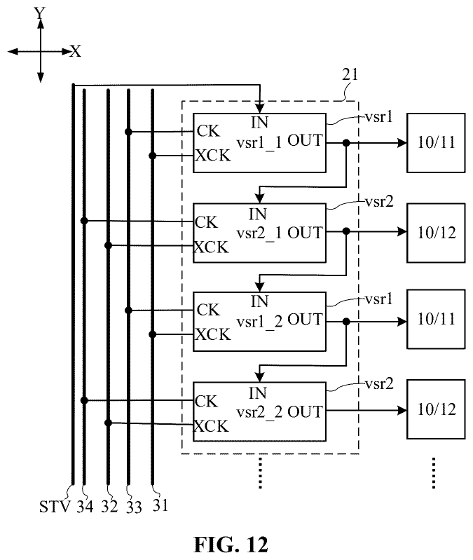

In other embodiments, as shown in FIG. 12, the first scanning circuit 21 includes a plurality of first shift registers vsr1 and a plurality of second shift registers vsr2 that are cascade.

The similarities between FIG. 12 and FIG. 6 will not be repeated, but the differences include that the clock terminal CK of the first shift register is also connected to the third clock line 33, the clock terminal CK of the second shift register is also connected to the fourth clock line 34, the third clock signal on the third clock line 33 and the first clock signal on the first clock line 31 are inverted signals, and the fourth clock signal on the fourth clock line 34 and the second clock signal on the second clock line 32 are inverted signals.

Exemplarily, the cut-off level on the third clock line 33 is equal to the cut-off level on the first clock line 31, and the active level on the third clock line 33 is equal to the active level on the first clock line 31. The duration of the active level on the third clock line 33 is equal to the duration of the active level on the first clock line 31.

A cut-off level on the fourth clock line 34 is equal to a cut-off level on the second clock line 32, an active level on the fourth clock line 34 is equal to an active level on the second clock line 32. The duration of the active level on the fourth clock line 34 is equal to the duration of the active level on the second clock line 32.

In this embodiment, two clock lines are configured to drive the first shift register, and the other two clock lines are configured to drive the second shift register, so as to better ensure the differentiation of scanning signals on the first scanning line and the second scanning line.

As shown in FIGS. 1 and 2, the duration for the gate of the driving transistor in the i^{th} row sub-pixel to write the data voltage is relatively long, resulting in different driving currents of the i^{th} row sub-pixel and the i+1^{th} row sub-pixel at the same target luminance, thereby resulting in a luminance difference between the two rows of sub-pixels. In addition to the manner in which the first scanning signal and the second scanning signal are differentiated in the above example, the data voltages accessed by the first sub-pixel and the second sub-pixel may be differentiated.

In some embodiments, at the same target luminance, the data voltage accessed by the first sub-pixel is not equal to the data voltage accessed by the second sub-pixel.

For example, at the same target luminance, the data voltage accessed by the first sub-pixel 11 is denoted as Vdata1, and the data voltage accessed by the second sub-pixel 12 is denoted as Vdata2, where Vdata1≠Vdata2. The magnitude relationship between Vdata1 and Vdata2 can be designed based on the variation relationship between driving current and data voltage.

Since the magnitude of the data voltage affects the magnitude of the driving current, by differentiating the data voltages connected to the first sub-pixel and the second sub-pixel, it is possible to compensate for the luminance difference caused by the data voltage writing duration of the first sub-pixel being longer than that of the second sub-pixel.

In some embodiments, as shown in FIG. 4, the driving transistor T3 is a P-type transistor, and the data voltage accessed by the first sub-pixel is smaller than the data voltage accessed by the second sub-pixel at the same target luminance.

When the driving transistor is a P-type transistor, the driving current and the data voltage conform to the relationship formula 1:

$$I = k 1 * {( PVDD - Vdata )}^{2} \qquad ( 1 )$$

The power supply voltage PVDD and the data voltage Vdata are both positive voltages, and Vdata is not greater than PVDD. The greater the data voltage Vdata, the smaller the driving current I, and the lower the luminance.

Since the data voltage is written to the first sub-pixel before the second sub-pixel, after the first scanning signal accessed by the first sub-pixel is switched from the active level to the cut-off level, the second transistor in the first sub-pixel is still turned on. Therefore, the data voltage is still written to the gate of the driving transistor in the first sub-pixel, and the writing of the data voltage is not stopped until the driving transistor in the first sub-pixel is turned to the cut-off state. That is, when the driving transistor is a P-type transistor, the duration for writing the data voltage of the first sub-pixel is longer than the duration for writing the data voltage of the second sub-pixel, and the data voltage of the first sub-pixel is more sufficiently written, resulting in a small driving current and relatively low luminance of the first sub-pixel and a large driving current and relatively high luminance of the second sub-pixel.

In this embodiment, when the driving transistor is a P-type transistor, the data voltage accessed by the first sub-pixel is designed to be smaller than the data voltage accessed by the second sub-pixel, so that the driving current of the first sub-pixel can be increased and the driving current of the second sub-pixel can be reduced to compensate for the problem that the luminance of the first sub-pixel is too low due to the long data voltage writing duration and the luminance of the second sub-pixel is too high due to the short data voltage writing duration.

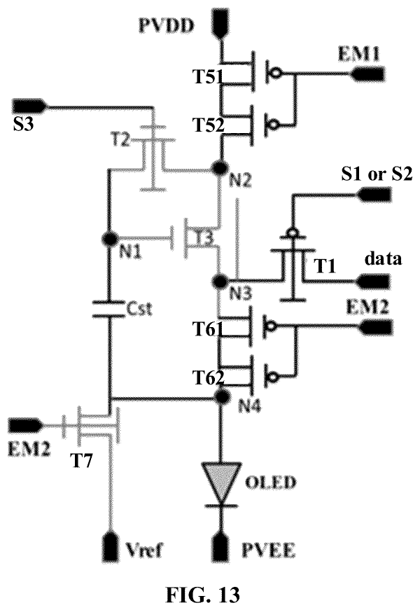

In some embodiments, as shown in FIG. 13, the driving transistor T3 is an N-type transistor, and the data voltage accessed by the first sub-pixel is greater than the data voltage accessed by the second sub-pixel at the same target luminance.

When the driving transistor is an N-type transistor, the driving current and the data voltage conform to the relationship formula 2:

$$I = k 2 * {( Vref - Vdata )}^{2} \qquad ( 2 )$$

The reference voltage Vref is a negative voltage, the data voltage Vdata is a positive voltage, and the larger the data voltage Vdata is, the larger the driving current I is, and the higher the luminance is.

Since the data voltage is written to the first sub-pixel before the second sub-pixel, after the first scanning signal accessed by the first sub-pixel is switched from the active level to the cut-off level, the second transistor in the first sub-pixel is still turned on. Therefore, the data voltage is still written to the gate of the driving transistor in the first sub-pixel, and the writing of the data voltage is not stopped until the driving transistor in the first sub-pixel is turned to the cut-off state. That is, when the driving transistor is an N-type transistor, the duration for writing the data voltage of the first sub-pixel is longer than the duration for writing the data voltage of the second sub-pixel, and the data voltage of the first sub-pixel is more sufficiently written, resulting in a large driving current and relatively high luminance of the first sub-pixel and a small driving current and relatively low luminance of the second sub-pixel.

In this embodiment, when the driving transistor is an N-type transistor, the data voltage accessed by the first sub-pixel is designed to be greater than the data voltage accessed by the second sub-pixel, so that the driving current of the first sub-pixel can be reduced and the driving current of the second sub-pixel can be increased to compensate for the problem that the luminance of the first sub-pixel is too high due to the long data voltage writing duration, and the luminance of the second sub-pixel is too low due to the short data voltage writing duration.

In addition to differentiating the first scanning signal and the second scanning signal, differentiating the data voltages accessed by the first sub-pixel and the second sub-pixel, differentiating the storage capacitances of the first sub-pixel and the second sub-pixel, differentiating the parasitic capacitances of the first sub-pixel and the second sub-pixel, differentiating the driving transistors of the first sub-pixel and the second sub-pixel, and the like, these differentiated designs will be described below.

In some embodiments, as shown in FIG. 4 or FIG. 13, the sub-pixel further includes a storage capacitor Cst, a first plate of the storage capacitor Cst is connected to the gate of the driving transistor T3, and a second plate of the storage capacitor Cst is electrically connected to a fixed potential. As shown in FIG. 4, the fixed potential is the power supply voltage PVDD, or as shown in FIG. 13, the fixed potential is the reference voltage Vref.

The storage capacitance in the first sub-pixel 11 is denoted as a first storage capacitance Cst1, and the storage capacitance in the second sub-pixel 12 is denoted as a second storage capacitance Cst2, and the overlapping area of the two plates of the first storage capacitance Cst1 is not equal to that of the second storage capacitance Cst2.

For example, the two plates of the first storage capacitor Cst1 and the two plates of the second storage capacitor Cst2 are respectively located in the same film layer.

It is understood that the capacitance value of the first storage capacitance Cst1 and the capacitance value of the second storage capacitance Cst2 are different.

The capacitance value of the storage capacitor will affect the speed at which the data voltage is written to the gate of the driving transistor. The larger the capacitance value of the storage capacitor, the slower the data voltage is written. Conversely, the smaller the capacitance value of the storage capacitor, the faster the data voltage is written.

In the present embodiment, by differentiating the capacitance values of the storage capacitors of the first sub-pixel and the second sub-pixel, it is possible to compensate for the luminance difference caused by the data voltage writing duration of the first sub-pixel being longer than the data voltage writing duration of the second sub-pixel.

As an example, the driving transistor is a P-type transistor, and the overlapping area of the two plates of the first storage capacitor Cst1 is larger than that of the second storage capacitor Cst2. In this way, the data voltage written to the gate of the driving transistor in the first sub-pixel is insufficient, and the gate voltage of the driving transistor in the first sub-pixel is reduced, thereby increasing the luminance of the first sub-pixel, and compensating for the problem that the luminance of the first sub-pixel is too low due to the long data voltage writing duration and the luminance of the second sub-pixel is too high due to the short data voltage writing duration.

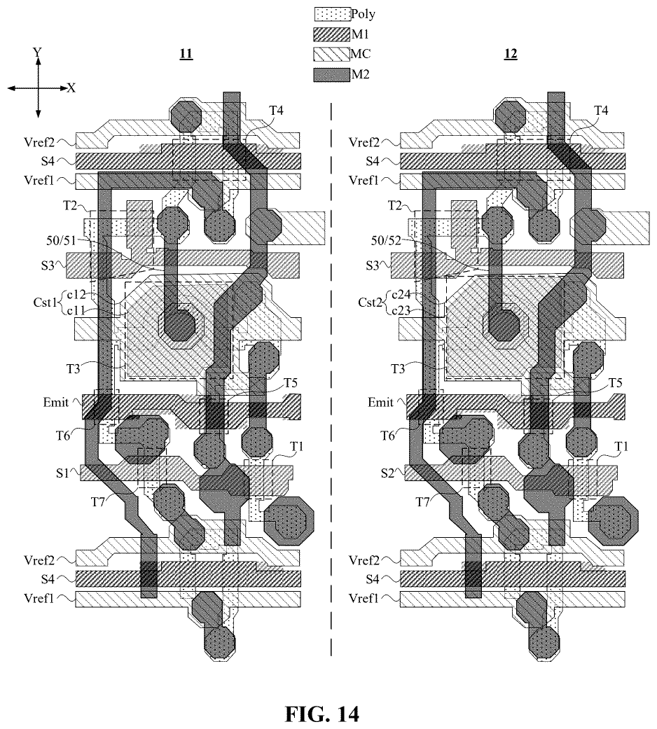

Exemplarily, as shown in FIG. 14, the driving transistor T3 is a P-type transistor, the first storage capacitor Cst1 includes a first plate c11 and a second plate c12, the second storage capacitor Cst2 includes a third plate c23 and a fourth plate c24, and the overlapping area of the first plate c11 and the second plate c12 is smaller than the overlapping area of the third plate c23 and the fourth plate c24. The first plate c11 and the third plate c23 are located in the same film layer, and the second plate c12 and the fourth plate c24 are located in the same film layer.

When the driving transistor is an N-type transistor, the overlapping area of the two plates of the first storage capacitor Cst1 is smaller than that of the second storage capacitor Cst2. In this way, the data voltage written to the gate of the driving transistor in the second sub-pixel is insufficient, and the gate voltage of the driving transistor in the second sub-pixel is reduced, thereby increasing the luminance of the second sub-pixel to compensate for the problem that luminance of the first sub-pixel is too high due to the long data voltage writing duration and the luminance is too low due to the short data voltage writing duration of the second sub-pixel.

In some embodiments, the channel width-to-length ratio of the driving transistor T3 in the first sub-pixel 11 is not equal to that in the second sub-pixel 12.

The larger the channel width-to-length ratio of the driving transistor, the larger the driving current.

In the present embodiment, it is possible to compensate for the luminance difference caused by the data voltage writing duration of the first sub-pixel being longer than the data voltage writing duration of the second sub-pixel by differentiating the channel width-length ratio of the driving transistors of the first sub-pixel and the second sub-pixel.

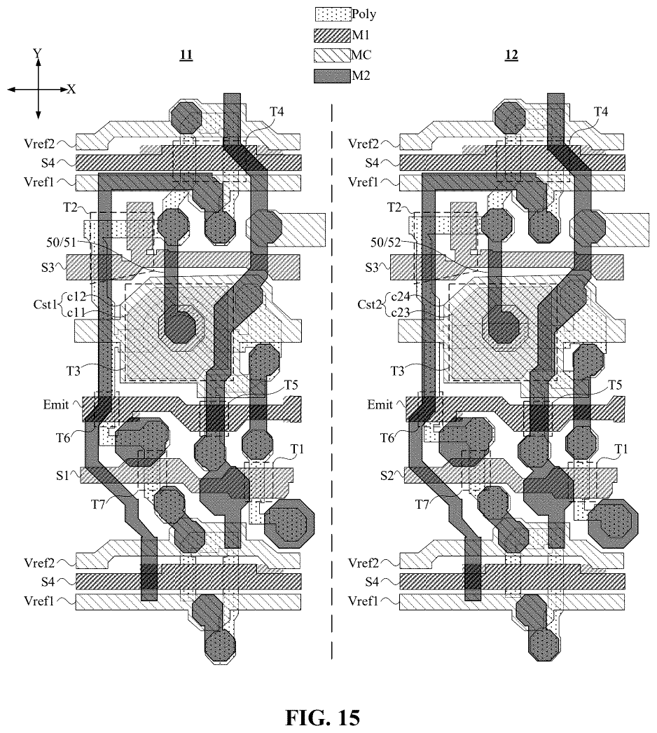

As an example, as shown in FIG. 15, the driving transistor is a P-type transistor, and the channel width-to-length ratio of the driving transistor T3 in the first sub-pixel 11 is larger than the channel width-to-length ratio of the driving transistor T3 in the second sub-pixel 12. In this way, the data voltage written to the gate of the driving transistor in the first sub-pixel is insufficient, and the gate voltage of the driving transistor in the first sub-pixel is reduced, thereby increasing the luminance of the first sub-pixel, and compensating for the problem that the luminance of the first sub-pixel is too low due to the long data voltage writing duration and the luminance of the second sub-pixel is too high due to the short data voltage writing duration.

When the driving transistor is an N-type transistor, the channel width-to-length ratio of the driving transistor T3 in the first sub-pixel 11 is smaller than the channel width-to-length ratio of the driving transistor T3 in the second sub-pixel 12. In this way, the luminance of the second sub-pixel can be increased to compensate for the problem that the luminance of the first sub-pixel is too high due to the long data voltage writing duration and the luminance is too low due to the short data voltage writing duration of the second sub-pixel.

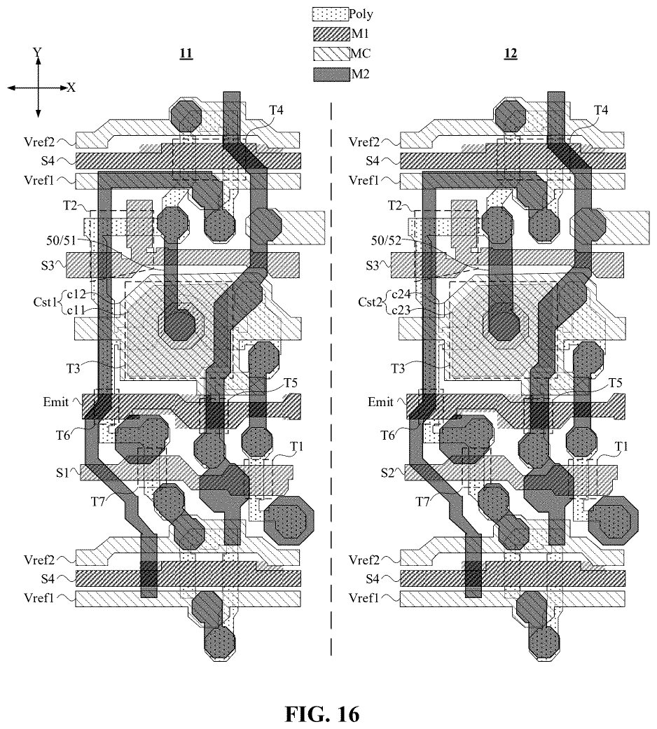

In some embodiments, as shown in FIG. 16, the display panel includes a connection line 50 connected to the gate of the driving transistor T3, and the connection line 50 at least partially overlaps the third scanning line S3 in the thickness direction of the display panel. One end of the connection line 50 is connected to the gate of the driving transistor T3 through a via, and the other end of the connection line 50 is connected to the first electrode of the second transistor T2 through a via.

For example, the gate g3 of the driving transistor T3 is located in the first metal layer M1, and the connection line 50 is located in the second metal layer M2.

The connection line 50 to which the first sub-pixel 11 is connected is denoted as a first connection line 51, and the connection line 50 to which the second sub-pixel 12 is connected is denoted as a second connection line 52, and the overlapping area between the first connection line 51 and the third scanning line S3 is not equal to the overlapping area between the second connection line 52 and the third scanning line S3.

The connection line 50 overlaps the third scanning line S3, and a portion where the connection line 50 overlaps the third scanning line S3 constitutes a parasitic capacitance connected to the gate of the driving transistor T3. The parasitic capacitances to which the driving transistor gates of the first sub-pixel and the second sub-pixel are connected are different. When the signal on the third scanning line S3 jumps, the gate potential of the driving transistor T3 is caused to jump under the coupling effect of the parasitic capacitance.

In the present embodiment, by designing the parasitic capacitance connected to the driving transistor gates of the first sub-pixel and the second sub-pixel to be different, it is possible to compensate for the luminance difference caused by the data voltage writing duration of the first sub-pixel being longer than the data voltage writing duration of the second sub-pixel.

As an example, the driving transistor is a P-type transistor, the active level of the upper end of the third scanning line S3 is a low level, and the overlapping area of the first connection line 51 to which the first sub-pixel 11 is connected and the third scanning line S3 is smaller than the overlapping area of the second connection line 52 to which the second sub-pixel 12 is connected and the third scanning line S3.

When the third scanning line S3 is switched from the low level to the high level, the gate potential of the driving transistor is pulled up. Since the overlapping area between the first connection line 51 and the third scanning line S3 to which the first sub-pixel 11 is connected is smaller, the gate potential of the driving transistor in the first sub-pixel 11 is pulled up by a smaller amplitude, thereby improving the luminance of the first sub-pixel to compensate for the problem that luminance of the first sub-pixel is low due to the long data voltage writing duration and the luminance of the second sub-pixel is high due to the short data voltage writing duration.

As another example, the driving transistor is an N-type transistor, the active level of the upper end of the third scanning line S3 is a low level, and the overlapping area of the first connection line to which the first sub-pixel 11 is connected and the third scanning line S3 is larger than the overlapping area of the second connection line to which the second sub-pixel 12 is connected and the third scanning line S3.

When the third scanning line S3 is switched from the low level to the high level, the gate potential of the driving transistor is pulled up. Since the overlapping area between the first connection line connected to the first sub-pixel 11 and the third scanning line S3 is larger, the gate potential of the driving transistor in the first sub-pixel 11 is pulled up by a larger amplitude, thereby reducing the luminance of the first sub-pixel to compensate for the problem that the luminance of the first sub-pixel is too high due to the long data voltage writing duration and the luminance of the second sub-pixel is too low due to the short data voltage writing duration.

In the above example, the third scanning line and the connection line overlap each other, and in other examples, another signal line and the connection line may overlap each other. For example, the overlapping area of the first connection line and the second signal line is not equal to the overlapping area of the second connection line and the second signal line. The second signal line is a signal line other than the third scanning line.

In some embodiments, as shown in FIG. 16, the line width of the first connection line 51 to which the first sub-pixel 11 is connected is not equal to the line width of the second connection line 52 to which the second sub-pixel 12 is connected.

Exemplarily, the first connection line 51 and the second connection line 52 extend along the second direction Y, the line width of the first connection line 51 is its width in the first direction X, and the line width of the second connection line 52 is its width in the first direction X.

In the present embodiment, the line width of the first connection line is not equal to the line width of the second connection line, so that the overlapping area of the first connection line and the third scanning line is different from the overlapping area of the second connection line and the third scanning line.

As an example, as illustrated in FIG. 16, the driving transistor is a P-type transistor, the active level of the upper end of the third scanning line S3 is a low level, and the line width of the first connection line 51 to which the first sub-pixel 11 is connected is smaller than the line width of the second connection line 52 to which the second sub-pixel 12 is connected.

As another example, the driving transistor is an N-type transistor, the active level of the upper end of the third scanning line S3 is a low level, and the line width of the first connection line 51 to which the first sub-pixel 11 is connected is larger than the line width of the second connection line 52 to which the second sub-pixel 12 is connected.

In the layouts shown in FIGS. 14 to 16, the transistors in the sub-pixels are P-type transistors for the purpose of illustration. The display panel includes a semiconductor layer Poly and a first metal layer M1, a capacitor metal layer MC, and a second metal layer M2 sequentially away from the semiconductor layer Poly. An insulating layer is provided between every two of the different metal layers, and an insulating layer is provided between the first metal layer M1 and the semiconductor layer Poly. In FIGS. 14 to 16, graphics of the same fill pattern represent structures located in the same film layer, and graphics of different fill patterns represent structures located in different film layers.

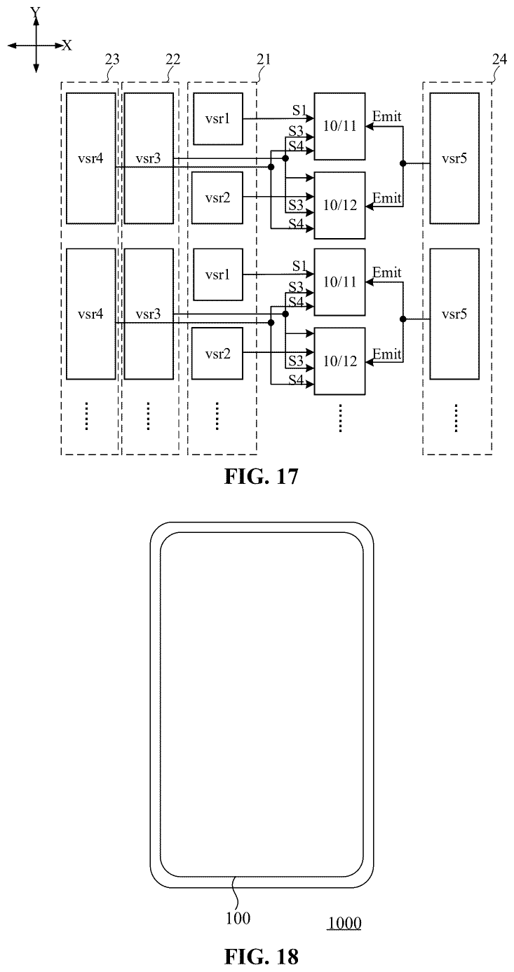

For example, referring to FIGS. 4 and 17, the display panel further includes a second scanning circuit 22 including a plurality of third shift registers vsr3 connected in cascade, and the third shift register vsr3 is connected to a third scanning line S3 to which the first sub-pixel 11 and the second sub-pixel 12 are connected.

The display panel further includes a third scanning circuit 23 including a plurality of fourth shift registers vsr4 connected in cascade, and the fourth shift register vsr4 is connected to a fourth scanning line S4 to which the first sub-pixel 11 and the second sub-pixel 12 are connected.

The display panel further includes a fourth scanning circuit 24 including a plurality of fifth shift registers vsr5 connected in cascade, and the fifth shift register vsr5 is connected to the light emission control line Emit to which the first sub-pixel 11 and the second sub-pixel 12 are connected.

The transistor in the embodiment of the present application may be an N-type transistor or a P-type transistor. In a specific implementation, the gate of each transistor is used as its control electrode, and according to the signal of the gate of each transistor and the type thereof, the first electrode may be used as the source electrode, the second electrode may be used as the drain electrode, or the first electrode may be used as the drain electrode, and the second electrode may be used as the source electrode, where no distinction is made. The turn-on level and the cut-off level in the embodiments of the present application are generalized, the on level refers to any level capable of turning on the transistor, and the cut-off level refers to any level capable of cutting off/turning off the transistor.

The present application also provides a display apparatus including the display panel provided in the present application. Please refer to FIG. 18, which is a structural schematic diagram of a display apparatus according to an embodiment of the present application. The display apparatus 1000 provided in FIG. 18 includes the display panel 100 provided in any of the above-described embodiments of the present application. In the embodiment of FIG. 18, the display apparatus 1000 is described only by taking a mobile phone as an example. It can be understood that the display apparatus provided in the embodiment of the present application may be another display apparatus having a display function, such as a wearable product, a computer, a television, or an in-vehicle display apparatus, and the present application does not specifically limit this. The display apparatus provided by the embodiment of the present application has the beneficial effects of the display panel provided by the embodiment of the present application. For details, the specific description of the display panel in each of the above embodiments can be referred to, and the present embodiment will not be repeatedly described here.

According to the embodiments of the present application as described above, these embodiments are not intended to be exhaustive in all details, nor are they intended to limit the application to the specific embodiments described. It will be apparent that many modifications and variations may be made in light of the above description. The purpose of selecting and specifically describing these embodiments in this specification is to better explain the principles and practical applications of the present application, so that those skilled in the art can make good use of the present application and modifications based on the present application. The present application is limited only by the claims and their full scope and equivalents.

1. A display panel, comprising:
a plurality of sub-pixels each comprising a driving transistor, a first transistor, and a second transistor, the first transistor being connected between a data line and a first electrode of the driving transistor, and the second transistor being connected between a second electrode of the driving transistor and a gate of the driving transistor, wherein
the plurality of sub-pixels comprise a first sub-pixel and a second sub-pixel, a gate of the first transistor in the first sub-pixel is connected to a first scanning line, a gate of the first transistor in the second sub-pixel is connected to a second scanning line, and gates of the second transistors in the first sub-pixel and the second sub-pixel are connected to a third scanning line;
in one screen refresh cycle, a first scan signal on the first scanning line comprises a first active level, a second scan signal on the second scanning line comprises a second active level, a third scan signal on the third scanning line comprises a third active level, a period of the third active level covers a period of the first active level and a period of the second active level, and a start time of the second active level is no earlier than an end time of the first active level;
a difference between a first cut-off level and the first active level of the first scanning signal is ΔV1, a difference between a second cut-off level and the second active level of the second scanning signal is ΔV2, a duration of the first active level is t1, and a duration of the second active level is t2, where |ΔV1|*t1<|ΔV2|*t2;
the display panel further comprises a connection line connected to the gate of the driving transistor, the connection line at least partially overlapping the third scanning line in a thickness direction of the display panel; and
an overlapping area between the connection line to which the first sub-pixel is connected and the third scanning line is not equal to an overlapping area between the connection line to which the second sub-pixel is connected and the third scanning line.

2. The display panel according to claim 1, further comprising a scanning circuit which comprises a first shift register and a second shift register, an output terminal of the first shift register being connected to the first scanning line and a first terminal of a first output transistor, and a second terminal of the first output transistor being connected to a first clock line; an output terminal of the second shift register being connected to the second scanning line and a first terminal of a second output transistor, and a second terminal of the second output transistor being connected to a second clock line;
wherein a difference between a third cut-off high level and a third active level of a first clock signal on the first clock line is ΔV3, and a difference between a fourth cut-off level and a fourth active level of a second clock signal on the second clock line is ΔV4, and |ΔV3|<|ΔV4|.

3. The display panel according to claim 2, wherein a high level on the first clock line is lower than a high level on the second clock line, or a low level on the first clock line is higher than a low level on the second clock line.

4. The display panel according to claim 1, wherein a scanning circuit of the display panel comprises a first shift register and a second shift register, an output terminal of the first shift register is connected to the first scanning line and a first terminal of a first output transistor, a second terminal of the first output transistor is connected to a first clock line, an output terminal of the second shift register is connected to the second scanning line and a first terminal of a second output transistor, and a second terminal of the second output transistor is connected to a second clock line; and
a duration of a third active level on the first clock line is t3, and a duration of a fourth active level on the second clock line is t4, where t3<t4.

5. The display panel according to claim 4, wherein a switching duration between a high level and a low level on the first clock line is t5, and a switching duration between a high level and a low level on the second clock line is t6, where t5>t6.

6. The display panel according to claim 4, wherein a line width of the first clock line is smaller than a line width of the second clock line.

7. The display panel according to claim 4, further comprising a compensation capacitor connected to the first clock line.

8. The display panel according to claim 4, further comprising a first signal line, and a spacing between the first clock line and the first signal line is smaller than a spacing between the second clock line and the first signal line.

9. The display panel according to claim 2, wherein
the scanning circuit comprises a plurality of the first shift registers and a plurality of the second shift registers, the first shift registers and the second shift registers being concatenated; and
the first shift registers are connected to the second clock line, and the second shift registers are connected to the first clock line.

10. The display panel according to claim 2, wherein
the scanning circuit comprises a plurality of the first shift registers and a plurality of the second shift registers, the first shift registers and the second shift registers being concatenated; and
the first shift registers are connected to a third clock line, the second shift registers are connected to a fourth clock line, a third clock signal on the third clock line and the first clock signal on the first clock line are inverted signals, and a fourth clock signal on the fourth clock line and the second clock signal on the second clock line are inverted signals.

11. The display panel according to claim 1, wherein a data voltage accessed by the first sub-pixel is not equal to a data voltage accessed by the second sub-pixel at a same target luminance.

12. The display panel according to claim 11, wherein the driving transistor is a P-type transistor, and the data voltage accessed by the first sub-pixel is lower than the data voltage accessed by the second sub-pixel at the same target luminance.

13. The display panel according to claim 11, wherein the driving transistor is an N-type transistor, and a data voltage accessed by the first sub-pixel is higher than a data voltage accessed by the second sub-pixel at the same target luminance.

14. The display panel according to claim 1, wherein each sub-pixel further comprises a storage capacitor, a first plate of which is connected to the gate of the driving transistor, and a second plate of which is electrically connected to a fixed potential; and
an overlapping area of the first plate and the second plate of the storage capacitor in the first sub-pixel is not equal to that in the second sub-pixel.

15. (canceled)

16. The display panel according to claim 1, wherein a line width of the connection line to which the first sub-pixel is connected is not equal to a line width of the connection line to which the second sub-pixel is connected.

17. The display panel according to claim 1, wherein a channel width-to-length ratio of the driving transistor in the first sub-pixel is not equal to that of the driving transistor in the second sub-pixel.

18. The display panel according to claim 1, wherein the first scanning line, the second scanning line, and the third scanning line extend in a first direction, and the first sub-pixel and the second sub-pixel are adjacent in a second direction, the first direction and the second direction intersecting.

19. A display apparatus comprising a display panel, the display panel comprising:
a plurality of sub-pixels each comprising a driving transistor, a first transistor, and a second transistor, the first transistor being connected between a data line and a first electrode of the driving transistor, and the second transistor being connected between a second electrode of the driving transistor and a gate of the driving transistor, wherein
the plurality of sub-pixels comprise a first sub-pixel and a second sub-pixel, a gate of the first transistor in the first sub-pixel is connected to a first scanning line, a gate of the first transistor in the second sub-pixel is connected to a second scanning line, and gates of the second transistors in the first sub-pixel and the second sub-pixel are connected to a third scanning line;
in one screen refresh cycle, a first scan signal on the first scanning line comprises a first active level, a second scan signal on the second scanning line comprises a second active level, a third scan signal on the third scanning line comprises a third active level, a period of the third active level covers a period of the first active level and a period of the second active level, and a start time of the second active level is no earlier than an end time of the first active level;
a difference between a first cut-off level and the first active level of the first scanning signal is ΔV1, a difference between a second cut-off level and the second active level of the second scanning signal is ΔV2, a duration of the first active level is t1, and a duration of the second active level is t2, where |ΔV1|*t1<|ΔV2|*t2;
the display panel further comprises a connection line connected to the gate of the driving transistor, the connection line at least partially overlapping the third scanning line in a thickness direction of the display panel; and
an overlapping area between the connection line to which the first sub-pixel is connected and the third scanning line is not equal to an overlapping area between the connection line to which the second sub-pixel is connected and the third scanning line.

20. The display panel according to claim 19, wherein display panel further comprises a scanning circuit which comprises a first shift register and a second shift register, an output terminal of the first shift register being connected to the first scanning line and a first terminal of a first output transistor, and a second terminal of the first output transistor being connected to a first clock line; an output terminal of the second shift register being connected to the second scanning line and a first terminal of a second output transistor, and a second terminal of the second output transistor being connected to a second clock line;
a difference between a third cut-off high level and a third active level of a first clock signal on the first clock line is ΔV3, and a difference between a fourth cut-off level and a fourth active level of a second clock signal on the second clock line is ΔV4, and |ΔV3|<|ΔV4|.
